(19) United States
(12) Patent Application Publication
(10) Pub. No.: US 2014/0219077 A1
(43) Pub. Date: Aug. 7, 2014

(54) TRAFFIC MANAGEMENT ACROSS DATA CENTER SITES

(71) Applicant: Hangzhou H3C Technologies Co., LTD., Hangzhou, Zhejiang (CN)

(72) Inventor: Wan Zhou, Haidian District (CN)

(73) Assignee: Hangzhou H3C Technologies Co., LTD., Hangzhou, Zhejiang (CN)

(21) Appl. No.: 14/345,652

(22) PCT Filed: Sep. 29, 2012
(86) PCT No.: PCT/CN2012/082424

§ 371 Date: Mar. 19, 2014

(30) Foreign Application Priority Data
Nov. 8, 2011 (CN) 201110349827.X

(51) Int. Cl. H04L 12/24

(52) U.S. Cl. CPC H04L 41/0668
USPC 370/217

(57) ABSTRACT

According to an example, a traffic management method includes that an edge device of a data center site receives first-hop gateway information of at least one remote data center sites from an edge device of the at least one remote data center site, checks whether a local first-hop gateway has failed, and in response to the local first-hop gateway being determined as having failed, transmits a packet originating within the data center site and addressed to the local first hop gateway to an edge device of a remote data center site.

### BACKGROUND

A data center is a center for providing various services and for performing data processing, data storage, and data exchange. In order to provide better services, a provider usually deploys multiple data center sites in different regions, so as to realize load sharing and high reliability. This typically requires the use of virtual machines that freely move among data center sites. Since the moving procedure of the virtual machines is transparent to users, the IP address of the virtual machines cannot be changed, and thus it is necessary to implement a layer-two network interconnection among the data center sites deployed in the different regions.

At present, both Ethernet Virtual Interconnection (EVI) technology of H3C Technologies CO., LTD and the Overlay Transport Virtualization (OTV) of Cisco Systems, Inc. are able to create a layer-two interconnection of data center sites. After the layer-two interconnection of data center sites is created, the same VLAN of different data center sites corresponds to the same master first-hop gateway, which is a layer-three gateway, and thus layer-three traffic related to the VLAN in each data center site is forwarded to a public network through the master first-hop gateway. Conventionally, a Virtual Router Redundancy Protocol (VRRP) and Hot Standby Router Protocol (HSRP) are run in a local first-hop gateway, and an edge device filters VRRP packets and HSRP packets, so as to optimize layer-three traffic inputted into and outputted from each data center site.

### BRIEF DESCRIPTION OF THE DRAWINGS

Features of the present disclosure are illustrated by way of example and not limited in the following figure(s), in which like numerals indicate like elements, in which:

FIG. 1 is a schematic diagram illustrating conventional layer-three traffic forwarding in a network where layer-three interconnection of EVI based data center sites has been created.

FIG. 2 is a schematic diagram illustrating conventional layer-three traffic forwarding, when a local first-hop gateway has failed, in the network where layer-three interconnection of data center sites shown in FIG. 1 has been created.

FIG. 3 is a flowchart illustrating a method of managing traffic across data center sites according to an example of the present disclosure.

FIG. 4 is a schematic diagram illustrating layer-three traffic forwarding in the network where layer-three interconnection of data center sites shown in FIG. 2 has been created according to an example of the present disclosure.

FIG. 5 is a schematic diagram illustrating the structure of an edge device according to an example of the present disclosure.

FIG. 6 is a schematic diagram illustrating the structure of an edge device according to another example of the present disclosure.

### DETAILED DESCRIPTION

For simplicity and illustrative purposes, the present disclosure is described by referring mainly to an example thereof. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure. Throughout the present disclosure, the terms “a” and “an” are intended to denote at least one of a particular element. As used herein, the term “includes” means includes but not limited to, the term “including” means including but not limited to. The term “based on” means based at least in part on.

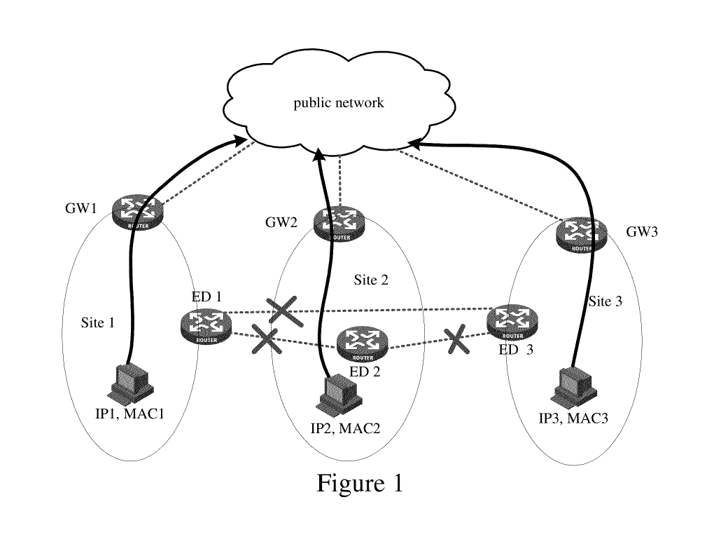

FIG. 1 is a schematic diagram illustrating conventional layer-three traffic forwarding in a network where a layer-two interconnection of EVI based data center sites has been created. FIG. 1 shows data center sites Site1, Site2, and Site3, which are all connected to a public network. The Site1 includes a master machine 1 whose IP address and MAC address are IP1 and MAC1 respectively, an edge device ED1, and a first-hop gateway GW1. The Site2 includes a master machine 2 whose IP address and MAC address are IP2 and MAC2 respectively, an edge device ED2, and a first-hop gateway GW2. The Site3 includes a master machine 3 whose IP address and MAC address are IP3 and MAC3 respectively, an edge device ED3, and a first-hop gateway GW3. The GW1, GW2, and GW3 belong to the same VLAN.

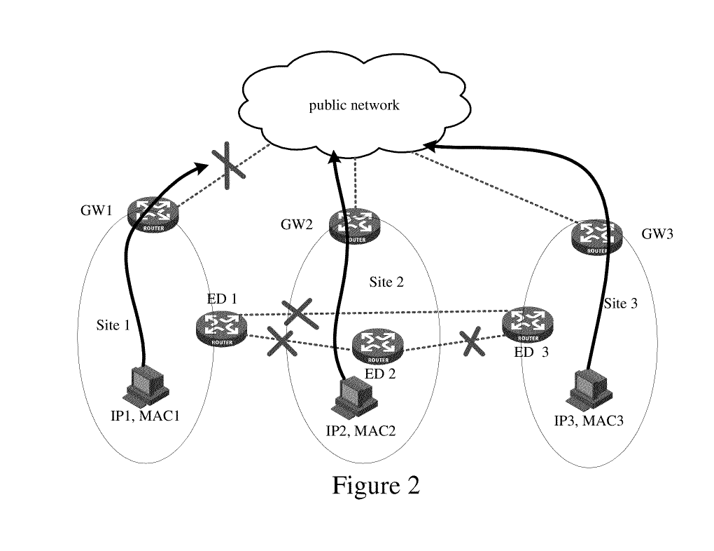

According to the EVI technology, the Site1, Site2, and Site3 create layer-two interconnection with other data center sites through respective edge devices (for instance, the dashed lines between the ED1, ED2, and ED3 shown in FIG. 1 indicate layer-two virtual connections between the data center sites). The VRRP is run on the GW1 of the Site1 and VRRP packets are filtered on the ED1. The VRRP packets are unable to be transmitted to the Site2 through the layer-two virtual connection between the ED1 and the ED2 (for instance, the “X” on the dashed line between the ED1 and the ED2 in FIG. 2 indicates that the VRRP packets are unable to be transmitted to an opposite data center site through the layer-two virtual connection, and the “X” on other layer-two virtual connections in FIG. 1 indicates the same meanings as mentioned above), and are also unable to be transmitted to the Site3 through the layer-two virtual connection between the ED1 and the ED3. In this way, the GW1 becomes the master first-hop gateway of the Site1 and layer-three traffic within the Site1 is forwarded to the public network through the GW1. Similarly, the GW2 becomes the master first-hop gateway of the Site2 and layer-three traffic within the Site2 is forwarded to the public network through the GW2. In addition, the GW3 becomes the master first-hop gateway of the Site3 and layer-three traffic within the Site3 is forwarded to the public network through the GW3.

Since the traffic within the data center site is transmitted through the first-hop gateway of the data center site, when a link between the first-hop gateway and the public network has failed, a layer-three traffic export of the data center site will be interrupted and thus will be unable to communicate with the outside. FIG. 2 is a schematic diagram illustrating conventional layer-three traffic forwarding, when a local first-hop gateway has failed, in the network where layer-two interconnection of data center sites shown in FIG. 1 has been created. As shown in FIG. 2, the link between the GW1 and the public network has failed, which results in that the GW1 fails. As such, the layer-three traffic within the Site1 is unable to be forwarded through the GW1, and thus services within the Site1 are interrupted.

In order to make the object, technical solution, and merits of the present disclosure clearer, the present disclosure will be illustrated in detail hereinafter with reference to the accompanying drawings and specific examples.

In practical applications, when multiple VLANs are deployed within a data center, different VLANs may correspond to different first-hop gateways. Since traffic management methods of the VLANs are the same, the traffic management method of one VLAN will be illustrated hereinafter.

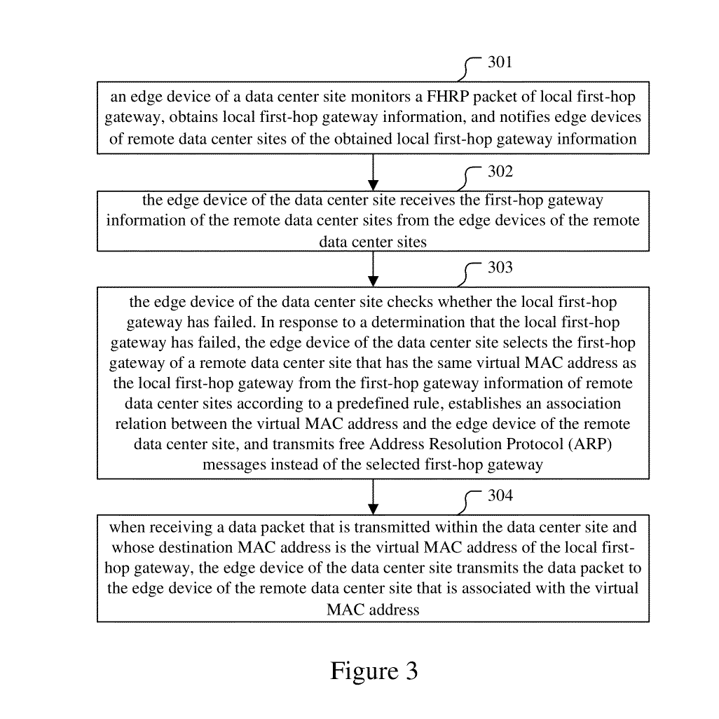

FIG. 3 is a flowchart illustrating a method of managing traffic across data center sites according to an example. The method is applied to a network where layer-two interconnection of data center sites has been created, and includes the following processes.

Block 301, an edge device of a data center site monitors a First Hop Redundancy Protocol (FHRP) packet of a local first-hop gateway, obtains local first-hop gateway information, and notifies edge devices of remote data center sites of the obtained local first-hop gateway information.

The FHRP packet may be a VRRP packet or a HSRP packet. The local first-hop gateway information may include a VLAN to which the local first-hop gateway belongs, a virtual IP address and virtual MAC address of the local first-hop gateway, and the priority of the local first-hop gateway.

After obtaining the local first-hop gateway information, the edge device of the data center site may store the local first-hop gateway information in a local first-hop gateway information database. A method of notifying the edge devices of the remote data center sites of the obtained local first-hop gateway information may include: carrying the obtained local first-hop gateway information in an ISIS LSP packet and transmitting the ISIS LSP packet to the edge devices of the remote data center sites.

Block 302, the edge device of the data center site receives the first-hop gateway information of the remote data center sites from the edge devices of the remote data center sites.

In this example, the edge device of the data center site notifies the edge devices of the remote data center sites of the local first-hop gateway information, receives the first-hop gateway information of the remote data center sites from the edge devices of the remote data center sites, and stores the first-hop gateway information of the remote data center sites in a remote first-hop gateway information database. When storing the first-hop gateway information of the remote data center sites, the edge device of the data center site may further store edge device information of remote data center sites respectively corresponding to the first-hop gateway information, for instance, IP addresses of the edge devices of the remote data center sites. While FIG. 3 shows block 302 as being performed after block 301, it is possible for block 302 to be performed first or for the blocks to be executed in parallel.

Block 303, the edge device of the data center site checks whether the local first-hop gateway has failed. In response to a determination that the local first-hop gateway has failed, the edge device of the data center site selects the first-hop gateway of a remote data center site that has the same virtual MAC address as the local first-hop gateway from the first-hop gateway information of remote data center sites according to a predefined rule, establishes an association relation between the virtual MAC address and the edge device of the remote data center site, and transmits free Address Resolution Protocol (ARP) messages instead of the selected first-hop gateway.

In this block, since the local first-hop gateway has failed, the edge device of the data center site needs to select the first-hop gateway of the remote data center site that has the same virtual MAC address as the local first-hop gateway, and layer-three traffic within the data center site is managed and forwarded to a public network by the selected first-hop gateway of the remote data center site.

The edge device of the data center site transmits the free ARP message instead of the selected first-hop gateway, where the source IP address and source MAC address of the free ARP message are respectively the same as the virtual IP address and virtual MAC address of the selected first-hop gateway of the remote data center site. Actually, since first-hop gateways in the same VLAN have the same virtual IP address and virtual MAC address, it can be deemed that the edge device of the data center site transmits the free ARP message instead of the local first-hop gateway within the data center site.

After the edge device of the data center site transmits the free ARP message instead of the selected first-hop gateway, packets for which layer-three forwarding is to be performed are not transmitted to the local first-hop gateway, but are transmitted to the edge device of the data center site.

Block 304, when receiving a data packet that is transmitted within the data center site and whose destination MAC address is the virtual MAC address of the local first-hop gateway, the edge device of the data center site transmits the data packet to the edge device of the remote data center site that is associated with the virtual MAC address.

After the local first-hop gateway has failed, the edge device of the data center site selects the first-hop gateway of the remote data center site, which has the same virtual MAC address as the local first-hop gateway, establishes the association relation between the virtual MAC address and the edge device of the remote data center site, and transmits the free ARP message instead of the selected first-hop gateway of the remote data center site within the data center site. After receiving the ARP message, each device in the data center site refreshes a port corresponding to the virtual MAC address, so as to transmit the packets for which layer-three forwarding is to be performed to the edge device of the data center site. In this way, when receiving a packet whose destination MAC address is the virtual MAC address of the local first-hop gateway, the edge device of the data center site determines the associated edge device of the remote data center site according to the destination MAC address of the packet, transmits the packet to the associated edge device of the remote data center site, and forwards the packet to the public network through the first-hop gateway of the remote data center site.

In practical applications, the local first-hop gateway may transmit the FHRP packet periodically. If the edge device of the data center site does not receive the FHRP packet of the local first-hop gateway within a period of time, an indication that the local first-hop gateway has failed is made. If aging processing is not performed for the local first-hop gateway, the edge device of the data center site possibly selects the failed local first-hop gateway to manage traffic, so as to result in the loss of traffic. In the example shown in FIG. 3, an aging timer may be used to perform aging processing for the local first-hop gateway information. After obtaining the local first-hop gateway information, if the local first-hop gateway information does not exist in the edge device of the data center site, the edge device of the data center site stores the local first-hop gateway information, and sets the aging timer corresponding to the local first-hop gateway information. If the local first-hop gateway information exists in the edge device of the data center, the edge device of the data center site refreshes the aging timer corresponding to the local first-hop gateway information.

If the edge device of the data center site does not receive the FHRP packet when the aging timer corresponding to the local first-hop gateway information expires, a determination that the local first-hop gateway has failed may be made. Otherwise, a determination that the local first-hop gateway has not failed may be made. In addition, when the local first-hop gateway has failed, the local first-hop gateway may transmit a FHRP packet whose priority is 0. And thus, if the edge device of the data center site receives the FHRP packet whose priority is 0 from the local first-hop gateway, a determination that the local first-hop gateway has failed may be made.

After the local first-hop gateway has failed, the edge device of the data center site may delete the local first-hop gateway information, and may notify the edge devices of the remote data center sites that the local first-hop gateway has failed, so that the edge devices of the remote data center sites may delete the local first-hop gateway information in time. In this way, the edge device of the data center site will not incorrectly select the failed first-hop gateway to manage traffic. Similarly, after the first-hop gateway of a remote data center site has failed, the edge device of the remote data center site notifies the edge device of the current data center site that the first-hop gateway of the remote data center site has failed. In this way, when receiving the notification from the edge device of the remote data center site, the edge device of the current data center site deletes the first-hop gateway information of the remote data center site.

In the example shown in FIG. 3, after the local first-hop gateway has failed, the first-hop gateway of a remote data center site is selected to manage traffic. When the local first-hop gateway recovers, the local first-hop gateway transmits the free ARP packet within the data center site where the local first-hop gateway is located, and retransmits the FHRP packet periodically. After receiving the FHRP packet transmitted by the local first-hop gateway, the edge device of the data center site may determine that the local first-hop gateway has recovered, the traffic may be forwarded to the public network through the local first-hop gateway, and association of the virtual MAC address of the local first-hop gateway with the edge device of the remote data center site may no longer be needed. Accordingly, the method may further include: In response to a determination that the local first-hop gateway has recovered, the association relation between the virtual MAC address of the local first-hop gateway and the edge device of the remote data center site associated with the virtual MAC address may be deleted. In addition, the edge devices of the remote data center sites may be notified of the local first-hop gateway information.

In the example shown in FIG. 3, the process of selecting the first-hop gateway of the remote data center site that has the same virtual MAC address as the local first-hop gateway from the first-hop gateway information of the remote data center sites according to the predefined rule may include: selecting the first-hop gateway of the remote data center site, which has the same virtual MAC address as the local first-hop gateway and has the highest priority from the first-hop gateway information of the remote data center sites. Or, the process of selecting the first-hop gateway of the remote data center site that has the same virtual MAC address as the local first-hop gateway from the first-hop gateway information of the remote data center sites according to the predefined rule may include: randomly selecting the first-hop gateway of the remote data center site that has the same virtual MAC address as the local first-hop gateway from the first-hop gateway information of the remote data center sites.

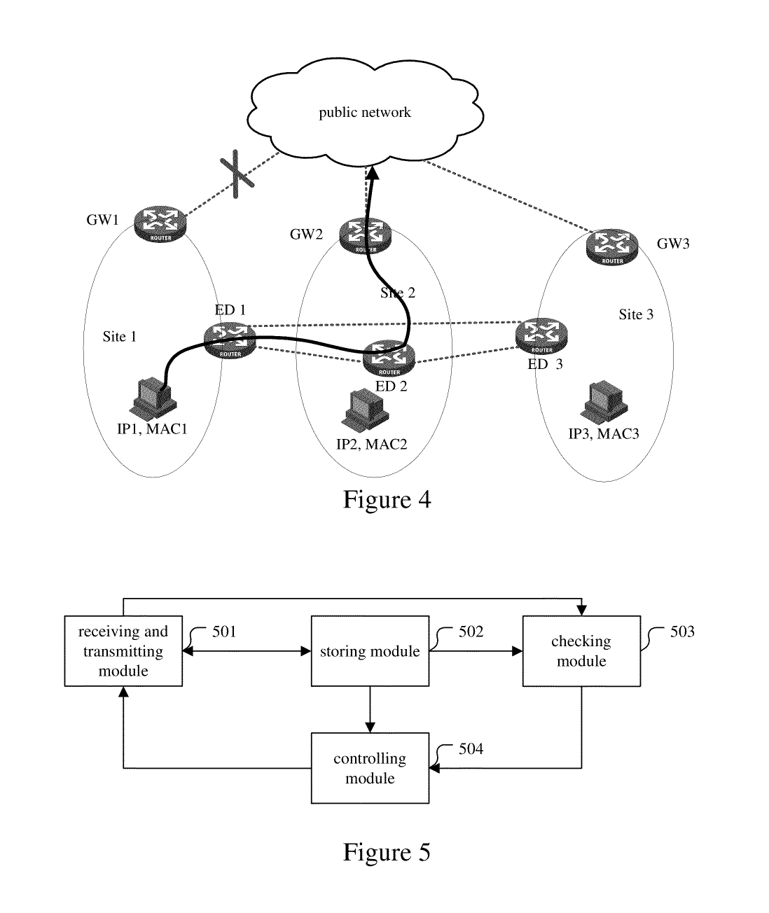

The example shown in FIG. 3 will be illustrated in detail hereinafter with reference to FIG. 4.

FIG. 4 is a schematic diagram illustrating layer-three traffic forwarding in the network where layer-two interconnection of data center sites shown in FIG. 2 has been created according to an example. It is supposed that the GW1, GW2, and GW3 are first-hop gateways of VLAN100, whose virtual IP addresses are IPv and virtual MAC addresses are MACv. The priority of the GW1 is 10, the priority of the GW2 is 20 and the priority of the GW3 is 15. In FIG. 4, the virtual IP address of the GW1 is IP1, and the virtual MAC address of the GW1 is MAC1; the virtual IP address of the GW2 is IP2, and the virtual MAC address of the GW2 is MAC2; and the virtual IP address of the GW3 is IP3, and the virtual MAC address of the GW3 is MAG3. Since the GW1, GW2 and GW3 belong to the same VLAN, their virtual IP addresses and virtual MAC addresses are the same respectively.

In the Site1, the GW1 transmits the FHRP packet periodically, the edge device ED1 intercepts the FHRP packet transmitted by the GW1, and obtains the local first-hop gateway information including VLAN100, IPv, MACv and Priority=10. Similarly, the GW2 transmits the FHRP packet periodically, the edge device ED2 intercepts the FHRP packet transmitted by the GW2, and obtains the local first-hop gateway information including VLAN100, IPv, MACv and Priority=20. The GW3 transmits the FHRP packet periodically, the edge device ED3 intercepts the FHRP packet transmitted by the GW3, and obtains the local first-hop gateway information including VLAN100, IPv, MACv and Priority=15.

After obtaining the local first-hop gateway information, the ED1, ED2, and ED3 notifies the edge devices of remote data center sites of the obtained local first-hop gateway information. The ED1 notifies the ED2 and ED3 of the obtained local first-hop gateway information, the ED2 notifies the ED1 and ED3 of the obtained local first-hop gateway information, and the ED3 notifies the ED1 and ED2 of the obtained local first-hop gateway information. In this way, the ED1, ED2, and ED3 also may obtain the first-hop gateway information of the remote data center sites. The local first-hop gateway information and the first-hop gateway information of the remote data center sites stored in the ED1, ED2, and ED3 are shown in Table 1.

TABLE 1

| | local first-hop gateway | first-hop gateway information of |
|---|---|---|
| | information | remote data center sites |
| ED1 | VLAN100, IPv, MACv | ED2, VLAN100, IPv, MACv and 20 |
| | and 10 | ED3, VLAN100, IPv, MACv and 15 |
| ED2 | VLAN100, IPv, MACv | ED1, VLAN100, IPv, MACv and 10 |
| | and 20 | ED3, VLAN100, IPv, MACv and 15 |
| ED3 | VLAN100, IPv, MACv | ED1, VLAN100, IPv, MACv and 10 |
| | and 15 | ED2, VLAN100, IPv, MACv and 20 |

Suppose the local first-hop gateway GW1 in the Site1 transmits the FHRP packet whose priority is 0 when failed, the ED1 determines that the GW1 has failed after receiving the FHRP packet whose priority is 0. And thus, the ED1 deletes the local first-hop gateway information corresponding to the GW1, and notifies the ED2 and ED3 that the GW1 has failed, so that the ED2 and ED3 delete the stored first-hop gateway information corresponding to the GW1. In this way, the local first-hop gateway information and the first-hop gateway information of the remote data center sites stored in the ED1, ED2, and ED3 are shown in Table 2.

TABLE 2

| | local first-hop gateway | first-hop gateway information of |
|---|---|---|
| | information | remote data center sites |
| ED1 | | ED2, VLAN100, IPv, MACv and 20 |
| | | ED3, VLAN100, IPv, MACv and 15 |
| ED2 | VLAN100, IPv, MACv | ED3, VLAN100, IPv, MACv and 15 |
| | and 20 | |
| ED3 | VLAN100, IPv, MACv | ED2, VLAN100, IPv, MACv and 20 |
| | and 15 | |

In order to transmit packets in the Site1 for which layer-three forwarding is to be performed to the public network, the ED1 selects the first-hop gateway of a remote data center site that has the same virtual MAC as the local first-hop gateway and has the highest priority from the stored local first-hop gateway information of remote data center sites. Since the first-hop gateway GW2 of the Site2 has the highest priority, the ED1 selects the first-hop gateway GW2 of the Site2, establishes an association relation between MACv and the ED2, and transmits a free ARP packet whose source IP address is IPv and source MAC address is MACv instead of the GW2. After the ED1 transmits the free ARP packet whose source IP address is IPv and source MAC address is MACv instead of the GW2, all master machines in the Site1 transmit the packets for which layer-three forwarding is to be performed (destination MAC addresses of these packets are MACv) to the ED1. After receiving the packets whose destination MAC addresses are MACv, the ED1 transmits, according to the association relation between MACv and the ED2, the received packets whose destination MAC addresses are MACv to the ED2 through the layer-two virtual connection between the ED1 and the ED2. After receiving the packets whose destination MAC addresses are MACv, the ED2 transmits the packets to the GW2, and then the GW2 forwards the packets to the public network. After the GW1 has failed, a forwarding path of layer-three traffic in the Site1 is shown in FIG. 4, which passes through the ED1, ED2, and GW2 and reaches the public network. Since the first-hop gateways of the Site2 and Site3 have not failed, the layer-three traffic forwarding is the same as that performed when the GW1 is not failed, and thus FIG. 4 does not show the forwarding path of layer-three traffic in the Site2 and Site3.

In addition, when the GW1 recovers, the GW1 retransmits the free ARP message, and transmits the FHRP packet periodically. After intercepting the FHRP packet of the GW1, the ED1 determines that the GW1 has recovered, and thus deletes the association relation between MACv and the ED2, and notifies the ED2 and ED3 of the local first-hop gateway information corresponding to the GW1. In this way, the packets in the Site1 for which layer-three forwarding is to be performed are forwarded to the public network through the GW1, and the local first-hop gateway information and the first-hop gateway information of the remote data center sites stored in the ED1, ED2 and ED3 become the contents shown in Table 1 again.

The method of managing traffic across data center sites provided by the examples has been illustrated in detail hereinbefore, and an example also provides an edge device, which can guarantee that the traffic is not interrupted when the local first-hop gateway has failed.

FIG. 5 is a schematic diagram illustrating the structure of an edge device according to an example. The edge device may include a receiving and transmitting module 501, a storing module 502 and, a checking module 503.

The checking module 503 is to check whether a local first-hop gateway has failed.

The receiving and transmitting module 501 is to receive first-hop gateway information of at least one remote data center site from an edge device of the at least one remote data center site, and store the first-hop gateway information of the at least one remote data center site in the storing module 502; in response to the local first-hop gateway being determined as having failed, transmit a packet originating within the data center site and addressed to the local first hop gateway to an edge device of a remote data center site.

The receiving and transmitting module 501 is to monitor a FHRP packet of a local first-hop gateway, obtain local first-hop gateway information, and notify edge devices of remote data center sites of the obtained local first-hop gateway information, where the local first-hop gateway information includes a virtual IP address and virtual MAC address of the local first-hop gateway; to receive first-hop gateway information of the remote data center sites from the edge devices of the remote data center sites, and store the first-hop gateway information of the remote data center sites in the storing module 502; when receiving a packet that is transmitted within a data center site where the edge device is located and whose destination MAC address is the virtual MAC address of the local first-hop gateway, to transmit the packet to the edge device of a remote data center site that is associated with the virtual MAC address.

The edge device further includes a controlling module 504. The controlling module 504 is to, in response to a determination that the local first-hop gateway has failed, select the first-hop gateway of a remote data center site that has the same virtual MAC address as the local first-hop gateway from the first-hop gateway information of the remote data center sites according to a predefined rule, establish an association relation between the virtual MAC address and the edge device of the remote data center site, notify the receiving and transmitting module 501 to transmit a free ARP message instead of the selected first-hop gateway within the data center site.

The receiving and transmitting module 501 may further, after obtaining the local first-hop gateway information, store the local first-hop gateway information if the local first-hop gateway information does not exist in the storing module 502, and set an aging timer corresponding to the local first-hop gateway information; otherwise, refresh the aging timer corresponding to the local first-hop gateway information stored in the storing module 502.

The checking module 503 may, if the receiving and transmitting module 501 receives a FHRP packet whose priority is 0 from the local first-hop gateway, or if the receiving and transmitting module 501 has not received the FHRP packet from the local first-hop gateway when the aging timer corresponding to the local first-hop gateway information stored in the storing module 502 expires, determine that the local first-hop gateway has failed; otherwise, determine that the local first-hop gateway has not failed.

The controlling module 504 may, in response to the determination that the local first-hop gateway has failed, delete the failed local first-hop gateway information, and notify the receiving and transmitting module 501 that the local first-hop gateway has failed.

The receiving and transmitting module 501 may, after receiving the notification from the controlling module 504, notify the edge devices of the remote data center sites that the local first-hop gateway has failed; when receiving a notification that the first-hop gateway of a remote data center site has failed from the edge device of the remote data center site, delete the failed first-hop gateway information of the remote data center site.

The checking module 503 may further check whether the local first-hop gateway has recovered.

The checking module 503 may determine that the local first-hop gateway has recovered when the receiving and transmitting module 501 receives the FHRP packet of the local first-hop gateway again.

The controlling module 504 may further, in response to a determination that the local first-hop gateway has recovered, delete the association relation between the virtual MAC address of the local first-hop gateway and the edge device of the remote data center site that is associated with the virtual MAC address.

The first-hop gateway information may further include the priority of first-hop gateway.

The controlling module 504 may select the first-hop gateway of the remote data center site that has the same virtual MAC address as the local first-hop gateway and has the highest priority from the first-hop gateway information of the remote data center sites.

The FHRP packet received by the receiving and transmitting module 501 may be a VRRP packet or a HSRP packet.

The receiving and transmitting module 501 may carry the local first-hop gateway information in an ISIS LSP packet and may transmit the ISIS LSP packet to the edge devices of remote data center sites.

The above modules are divided by logical functions, and in practical applications, the function of one module may be implemented by multiple modules, or the functions of multiple modules may be implemented by one module. The edge device may include other modules in another example.

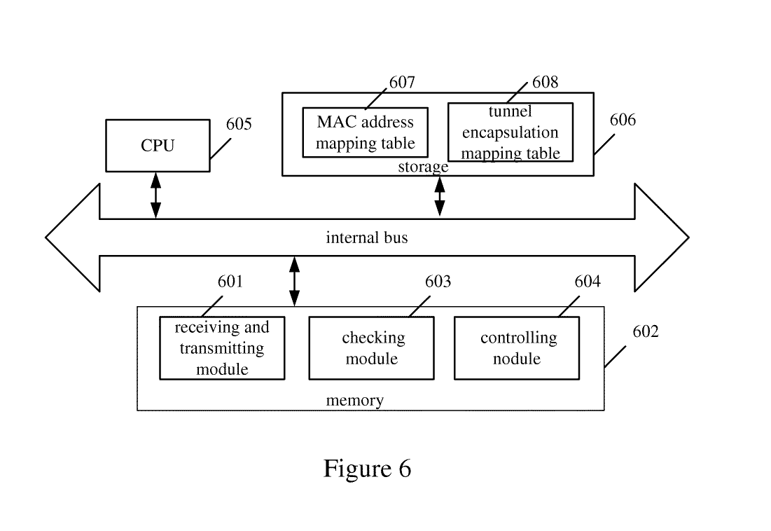

The various modules may be implemented as hardware, software or a combination thereof. FIG. 6 is a schematic diagram illustrating the structure of an edge device according to one example. In FIG. 6, the edge device includes a memory 602, a CPU 605, and a storage 606 connected with each other via an internal bus. The memory stores modules of machine readable instructions executable by the CPU 605, including a transmitting module 601, a checking module 603 and a controlling module 604. The storage stores a MAC address mapping table 607 and a tunnel encapsulation mapping table 608. Functions of the receiving and transmitting module 601, the storing module 602, the checking module 603 and the controlling nodule 604 are similar with the functions of the receiving and transmitting module 501, the storing module 502, the checking module 503 and the controlling module 504 shown in FIG. 5. Functions of the modules 601, 602, 603, and 604 are mainly initiated or directed by the modules 601, 602, 603, and 604. The functions may be implemented with the assistance of other modules, and may involve cooperation of multiple modules, e.g., may utilize processing functions of the CPU, may read information from the storage, may relay on the internal bus for data transmission, and etc. To be concise, the functions are described as implemented by the modules 601, 602, 603, and 604. In other examples some or all of the functions provided by modules 601, 603 and 604 may be provided by an ASIC or dedicated logic circuitry.

From the above discussion, it may be seen that, the edge device obtains the local first-hop gateway information, notifies the edge devices of the remote data center sites of the obtained local first-hop gateway information, and receives the first-hop gateway information of the remote data center sites from the remote data center sites. When the local first-hop gateway has failed, the edge device of the current data center site selects the first-hop gateway of a remote data center site to manage layer-three traffic, so as to guarantee that the traffic is not interrupted when the local first-hop gateway has failed.

The methods, modules and devices described herein may be implemented by hardware, machine-readable instructions or a combination of hardware and machine-readable instructions. Machine-readable instructions used in the examples disclosed herein may be stored in storage medium readable by multiple processors, such as hard drive, CD-ROM, DVD, compact disk, floppy disk, magnetic tape drive, RAM, ROM or other proper storage device. Or, at least part of the machine-readable instructions may be substituted by specific-purpose hardware, such as custom integrated circuits, gate array, FPGA, PLD and specific-purpose computers and so on.

A machine-readable storage medium is also provided, which is to store instructions to cause a machine to execute a method as described herein. Specifically, a system or apparatus having a storage medium that stores machine-readable program codes for implementing functions of any of the above examples and that may make the system or the apparatus (or CPU or MPU) read and execute the program codes stored in the storage medium.

In this situation, the program codes read from the storage medium may implement any one of the above examples, thus the program codes and the storage medium storing the program codes are part of the technical scheme.

The storage medium for providing the program codes may include floppy disk, hard drive, magneto-optical disk, compact disk (such as CD-ROM, CD-R, CD-RW, DVD-ROM, DVD-RAM, DVD-RW, DVD+RW), magnetic tape drive, Flash card, ROM and so on. Optionally, the program code may be downloaded from a server computer via a communication network.

It should be noted that, alternatively to the program codes being executed by a computer, at least part of the operations performed by the program codes may be implemented by an operation system running in a computer following instructions based on the program codes to realize a technical scheme of any of the above examples.

In addition, the program codes implemented from a storage medium are written in a storage in an extension board inserted in the computer or in a storage in an extension unit connected to the computer. In this example, a CPU in the extension board or the extension unit executes at least part of the operations according to the instructions based on the program codes to realize a technical scheme of any of the above examples.

Although described specifically throughout the entirety of the instant disclosure, representative examples of the present disclosure have utility over a wide range of applications, and the above discussion is not intended and should not be construed to be limiting, but is offered as an illustrative discussion of aspects of the disclosure.

What has been described and illustrated herein is an example along with some of its variations. The terms, descriptions and figures used herein are set forth by way of illustration only and are not meant as limitations. Many variations are possible within the spirit and scope of the subject matter, which is intended to be defined by the following claims—and their equivalents—in which all terms are meant in their broadest reasonable sense unless otherwise indicated.

What is claimed is:

1. A method of managing traffic across data center sites, comprising:
receiving, by an edge device of a data center site, first-hop gateway information of at least one remote data center sites from an edge device of the at least one remote data center site;
checking, by the edge device of the data center site, whether a local first-hop gateway has failed;
in response to the local first-hop gateway being determined as having failed, transmitting, by the edge device of the data center site, a packet originating within the data center site and addressed to the local first hop gateway to an edge device of a remote data center site.

2. The method of claim 1, further comprising:
obtaining, by the edge device of the data center site, local first-hop gateway information, and notifying the edge device of the at least one remote data center site of the obtained local first-hop gateway information, wherein the local first-hop gateway information includes a virtual IP address and virtual MAC address of the local first-hop gateway.

3. The method of claim 2, wherein the obtaining, by the edge device of the data center site, the local first-hop gateway information comprises:
obtaining, by the edge device of the data center site, the local first-hop gateway information through monitoring a First Hop Redundancy Protocol (FHRP) packet of the local first-hop gateway.

4. The method of claim 1, wherein the transmitting, by the edge device of the data center site, the packet originating within the data center site and addressed to the local first hop gateway to the edge device of the remote data center site comprises:
in response to the local first-hop gateway being determined as having failed,
selecting, by the edge device of the data center site, the first-hop gateway of a remote data center site that has the same virtual MAC address as the local first-hop gateway from the first-hop gateway information of the remote data center sites according to a predefined rule;
establishing an association relation between the virtual MAC address and the edge device of the remote data center site; and
transmitting a free Address Resolution Protocol (ARP) message instead of the selected first-hop gateway within the data center site; and
in response to receipt of a packet that is transmitted within the data center site and whose destination MAC address is the virtual MAC address of the local first-hop gateway, transmitting, by the edge device of the data center site, the packet to the edge device of the remote data center site that is associated with the virtual MAC address.

5. The method of claim 3, after obtaining the local first-hop gateway information, further comprising:
storing, by the edge device of the data center site, the local first-hop gateway information if the local first-hop gateway information does not exist in the edge device of the data center site, and setting an aging timer corresponding to the local first-hop gateway information; otherwise, refreshing the aging timer corresponding to the local first-hop gateway information; and
wherein checking whether the local first-hop gateway has failed comprises: if the edge device of the data center site receives a FHRP packet whose priority is 0 from the local first-hop gateway, or if the edge device of the data center site has not received the FHRP packet from the local first-hop gateway when the aging timer corresponding to the local first-hop gateway information expires, determining that the local first-hop gateway has failed; otherwise, determining that the local first-hop gateway has not failed.

6. The method of claim 5, further comprising:
following a determination that the local first-hop gateway has failed,
deleting, by the edge device of the data center site, the failed local first-hop gateway information; and
notifying the edge device of the at least one remote data center site that the local first-hop gateway has failed;
following receipt of a notification that the first-hop gateway of a remote data center site has failed from the edge device of the remote data center site, deleting, by the edge device of the data center site, the failed first-hop gateway information of the remote data center site.

7. The method of claim 6, further comprising:
checking, by the edge device of the data center site, whether the local first-hop gateway has recovered;
in response to the local first-hop gateway being determined as having recovered, deleting, by the edge device of the data center site, the association relation between the virtual MAC address of the local first-hop gateway and the edge device of the remote data center site associated with the virtual MAC address.

8. The method of claim 4, wherein the first-hop gateway information further includes the priority of first-hop gateway; and
wherein selecting the first-hop gateway of the remote data center site that has the same virtual MAC address as the local first-hop gateway from the first-hop gateway information of the remote data center sites according to the predefined rule comprises: selecting the first-hop gateway of a remote data center site that has the same virtual MAC address as the local first-hop gateway and has the highest priority from the first-hop gateway information of the remote data center sites.

9. An edge device, comprising:
a receiving and transmitting module, a storing module and a checking module;
wherein the checking module is to:
check whether a local first-hop gateway has failed;
wherein the receiving and transmitting module is to:
receive first-hop gateway information of at least one remote data center site from an edge device of the at least one remote data center site, and store the first-hop gateway information of the at least one remote data center site in the storing module; in response to the local first-hop gateway being determined as having failed, transmit a packet originating within the data center site and addressed to the local first hop gateway to an edge device of a remote data center site.

10. The edge device of claim 9, wherein
the receiving and transmitting module is to:
obtain local first-hop gateway information, and notifying the edge device of the at least one remote data center site of the obtained local first-hop gateway information, wherein the local first-hop gateway information includes a virtual IP address and virtual MAC address of the local first-hop gateway.

11. The edge device of claim 9, wherein
the receiving and transmitting module is to:
obtain the local first-hop gateway information through monitoring a First Hop Redundancy Protocol (FHRP) packet of the local first-hop gateway.

12. The edge device of claim 9, further comprising a controlling unit;
wherein the controlling module is to, in response to a determination that the local first-hop gateway has failed,
select the first-hop gateway of the remote data center site that has the same virtual MAC address as the local first-hop gateway from the first-hop gateway information of the remote data center sites according to a predefined rule, establish an association relation between the virtual MAC address and the edge device of the remote data center site, and notify the receiving and transmitting module to transmit a free ARP message instead of the selected first-hop gateway within the data center site;
the receiving and transmitting module is further to, in response to receipt of a packet that is transmitted within a data center site where the edge device is located and whose destination MAC address is the virtual MAC address of the local first-hop gateway, transmit the packet to the edge device of a remote data center site that is associated with the virtual MAC address.

13. The edge device of claim 11, wherein
the receiving and transmitting module is further to, after obtaining the local first-hop gateway information, store the local first-hop gateway information if the local first-hop gateway information does not exist in the storing module, and set an aging timer corresponding to the local first-hop gateway information; otherwise, refresh the aging timer corresponding to the local first-hop gateway information stored in the storing module; and
the checking module is to, if the receiving and transmitting module receives a FHRP packet whose priority is 0 from the local first-hop gateway, or if the receiving and transmitting module has not received the FHRP packet from the local first-hop gateway when the aging timer corresponding to the local first-hop gateway information stored in the storing module expires, determine that the local first-hop gateway has failed; otherwise, determine that the local first-hop gateway has not failed.

14. The edge device of claim 13, wherein
the controlling module is to, in response to the determination that the local first-hop gateway has failed, delete the failed local first-hop gateway information, and notify the receiving and transmitting module that the local first-hop gateway has failed; and
the receiving and transmitting module is to, after notification is received from the controlling module, notify the edge devices of the remote data center sites that the local first-hop gateway has failed; and in response to receipt of a notification that the first-hop gateway of a remote data center site has failed from the edge device of the remote data center site, delete the failed first-hop gateway information of the remote data center site.

15. The edge device of claim 14, wherein
the checking module is further to check whether the local first-hop gateway has recovered; and
the controlling module is further to, in response to a determination that the local first-hop gateway has recovered, delete the association relation between the virtual MAC address of the local first-hop gateway and the edge device of the remote data center site which is associated with the virtual MAC address.
